(19) United States
(12) Patent Application Publication
(10) Pub. No.: US 2005/0177561 A1
(43) Pub. Date: Aug. 11, 2005

(54) Learning search algorithm for indexing the web that converges to near perfect results for search queries

(76) Inventors: Kumaresan Ramanathan, Nashua, NH (US); Manjula Sundharam, Nashua, NH (US)

Correspondence Address: Kumaresan Ramanathan, 29 Chadwick Circle Apt F, Nashua, NH, 03062, US

(21) Appl. No.: 11/047,936

(22) Filed: Feb. 1, 2005

Related U.S. Application Data
(60) Provisional application No. 60/542,745, filed on Feb. 6, 2004.
(60) Provisional application No. 60/580,528, filed on Jun. 17, 2004.

(51) Int. Cl. G06F 17/30; G06F 7/00

(52) U.S. Cl. 707/3

(57) ABSTRACT

An improved method for retrieving documents from the web and other databases that uses a process of continuous improvement to converge towards near-perfect results for search queries. The method is very highly scalable, yet delivers very relevant search results.

### CROSS-REFERENCE TO RELATED APPLICATIONS

This application claims the benefit of Provisional Patent Application Ser. No. 60/542745 filed on Feb. 6, 2004 and Provisional Patent Application Ser. No. 60/580528 filed on Jun. 17, 2004.

### FEDERALLY SPONSORED RESEARCH

Not applicable.

### SEQUENCE LISTING OR PROGRAM

Not applicable.

### BACKGROUND OF THE INVENTION

This invention deals broadly with the subject of retrieving documents in response to a query. There are primarily two contrasting approaches that can be followed for this purpose. One is to analyze a query and use a generic algorithm that searches through a document collection to find matches. The other approach is to initially accept domain knowledge about each document in the collection. Using this domain knowledge it becomes possible to determine the queries that match each document.

This situation is described in FIG. 12. The two axes of the chart are scalability and accuracy. Most generic algorithms that don't accept domain-specific information for each document are best described by the oval labeled 1210. Generic algorithms are very scalable. Since they don't need domain knowledge about each document, they can be applied to very large document collections. Most search engines that index the web (such as Google, Yahoo and MSN) use generic algorithms. Since the algorithms are already very scalable, most of their efforts are focused on making them more accurate 1220. Generic algorithms will henceforth be called regular search in this specification.

The other class of algorithms accepts domain knowledge about each document. This domain knowledge is often in the form of “matching rules” or other procedural scripts. Since each document is associated with its own body of procedural domain knowledge, it is reasonable to think of each document as an “object” that contains both data as well as behavior. In terms of an analogy with Java or C++ objects, the domain knowledge corresponds to methods and the contents of the document correspond to data fields. Since each document has its own methods, the process of search may be thought of as sending the query to each document “object” and asking each document if the query matches it or not. These algorithms will henceforth be called “reverse search” in the rest of this specification. The reason for calling it reverse search will also be discussed later.

Unlike generic algorithms, algorithms that have domain specific knowledge about each document are usually very accurate. The reasons for this accuracy will be discussed later in this specification. However, domain knowledge is usually created by a human. The cost of generating accurate and reliable domain knowledge is very high, therefore such algorithms are usually not very scalable as represented by the oval 1240. Surprisingly, there has been very little research into methods of making these algorithms more scalable. The search method described here follows the approach of 1230. Since algorithms that use domain specific knowledge are already very accurate, we merely need to make them more scalable.

There is yet another technique for search. This is to create an ontology of domain specific knowledge for a specific industry or subject. This ontology is not created for any one document, but is instead meant to describe a collection of related documents that describe some topic. When a query is entered, search-engines will process the query against the ontology and find appropriate matches from among the documents. The algorithms that process ontologies are fairly generic, but not as generic as the completely domain-independent systems. At the same time, each document does not have its own domain knowledge. So in terms of scalability and accuracy, this approach is intermediate between completely generic methods (regular search) and highly domain specific approaches (reverse search).

The rest of this section is a brief overview of existing search technologies and their relative advantages and disadvantages.

The main problem with existing search technology is the large number of irrelevant responses for queries that attempt to access niche content. For example, Google's page ranking technology gives importance to popular web sites, but sometimes the user is actually looking for an unpopular niche web site with information that is of interest only to a few people. If such a site uses the same vocabulary as more popular sites, it will be drowned out in the flood of more popular web sites that are returned to the user. The following sections discuss some of the more popular search techniques and their shortcomings.

Keyword Search

One of the earliest search mechanisms on the web was simple keyword search. The main problem with keyword search is the large number of unranked matches that are returned for common words. When searching a space of billions of documents, it is quite possible that the search query returns more than 100000 documents!

Another problem with simple keyword search is that it is exceptionally easy to spam the search engine. All website authors need to do is add more words in their documents and their content will be shown to more users.

Optimized Keyword Search

The problems with simple keyword search led to the development of better ways of ranking the results of keyword search. Google's Pagerank, citation counting, and keyword clustering are some of the more commonly used techniques.

Citation counting uses the number of pages that link to a website as an indication of its correct rank in search results. Pagerank improves on this by considering the importance of the citation sources in determining the final rank of a page.

The main problem with these ‘intelligent’ keyword search mechanisms is their focus on ambiguous searches. Any query that is expressed in terms of keywords is usually ambiguous. Therefore, the best that a search engine can do is to return the most ‘important’ pages that match those keywords. If the user is looking for information that is of niche interest, it is possible that the page will be ranked low and very difficult to find with a keyword search.

Hierarchical Directories

One of the earliest ways to navigate the web was through hierarchical directories. Yahoo has one of the oldest commercial directories. A directory allows users to traverse a hierarchy of classifications until they find what they need.

Directories worked well when the web was small. As the web has grown in size, the usefulness of directories has diminished.

The main problem is that users must understand how web pages are classified in order to find what they need. If the information they are looking for has been classified in a manner that they do not expect, they are unlikely to find it even if the web page they seek is in the directory.

Another problem with directories is the manual effort that must be invested by disinterested individuals (usually editors employed by the directory's owner) to add and classify web sites. This effort is not trivial. As a result, the largest directories available today classify only a small fraction of the entire web.

As the difference between the total size of the web and the fraction indexed in a directory grows, the usefulness of directories diminishes further. We expect that directories will continue to fall behind as the web grows.

Searchable Directories

One problem with directories is easily fixed. If content is difficult to find by navigating through the classification hierarchy, why not allow users to search the directory? This works well for finding information that is easy to express using keywords, but as might be expected, it suffers from many of the same problems as keyword searches.

Learning Searches

There has been some work done over the last few years on learning searches. Unfortunately the methods explored so far have enjoyed very limited success. There are a number of problems with existing learning searches:

(i) Expecting Searchers to Train Engine

People who use search engines are in a hurry. Other than pure altruism they have little incentive to expend effort in training a search engine. Systems that rely on searchers to train them often find it difficult to receive the required level of training.

(ii) Using the Training Information

Once information to ‘learn’ has been gathered, it must be used effectively to modify future search results. Existing learning mechanisms are not scalable enough to apply to the entire web.

(iii) Ambiguous Queries

Many queries entered into keyword search engines are ambiguous. For example: “Bill Clinton” is a common query. But what does it ask for? Does the searcher want to learn more about the political career of Bill Clinton, his term in office or about his personal life? Any attempt to learn from the way searchers view results to this query will be a matter of guesswork.

Though learning search engines have many problems, we believe that it is the only practical way to produce highly relevant results. Later sections of this paper will present a highly scalable learning algorithm that overcomes all the difficulties mentioned here.

Semantic Web

Many people hope that a semantic web can be created—one that contains not just human readable text and graphics, but also machine processable semantic information. Proponents argue that by using this information, computers can understand the content of web pages and thereby allow information to be processed automatically. If the semantic web came to pass, search would be much more precise. The main problems with the semantic web are related to pragmatics. There currently exists no “killer-app” that justifies the effort required to author semantic annotations. RDF and OWL are powerful, but many crucial algorithms do not scale well to billions of pages.

In this paper we present a highly scalable learning algorithm for search that performs at least as well as semantics enhanced search. Though semantic annotation is potentially very useful for other applications, it is not necessary for precise web search.

### SUMMARY

Intuitively the principle on which this search method is based may be described as follows: Suppose you are creating a new web page. You are probably publishing the web page because you wish to make some unique content available to Internet users. At the same time, there are already 4-5 billion pages on the Internet. Therefore it stands to reason that there are only a small number of search queries for which your new page is the best possible response. As the author you probably have a good idea what these queries are for which your page is the best possible answer. Now further suppose you are given some mechanism that makes it possible to list out (with relatively little effort) those specific queries for which your page is the best response. Such mechanisms already exist and are used in automated-response systems for customer-service. Once you have described the queries, it becomes possible for a search engine to show your page at the top of the list when any of those specific queries are entered by users. If not just you, but most other publishers were also to provide such descriptions of queries for which their respective pages are the best answer, a search engine could produce the best possible answer to most queries. The problem is that each publisher will want his/her page to be shown to as many users as possible. So when publishers are independent (not cooperating) there is strong incentive to cheat. To defeat this problem, we create a stronger incentive that prevents cheating and keeps publishers honest. One way is to measure honesty using user feedback. The honesty measure may be used to reward honest publishers with good link placement and punish dishonest ones with poor placement. With a good incentive mechanism, this system will converge towards producing near-perfect results for search queries.

Another way to describe the process used in this search algorithm is through an analogy. Consider what a king would do if he were in need of information. He would issue a proclamation describing the information he needed. Experts in the kingdom who can help will respond to the query. There is a strong disincentive to waste the king's time with irrelevant responses. An expert who provides useful information sees his/her reputation in the kingdom greatly enhanced while one that provides irrelevant information sees his/her reputation suffer. This process (as described so far) is inefficient because the experts are studying each query and responding manually. Instead if we could automate this process, then we will be able to handle an indefinite number of queries and yet get highly relevant responses. The algorithm presented here provides for such automation, therefore it is very scalable.

This algorithm is fundamentally different from the regular search algorithms used by most existing search engines. Instead of analyzing a query and then trying to find a matching document, each document contains rules that describe what queries it will match with. Since this is in some the sense the reverse of what existing search systems do, we call it reverse search.

The principle of reverse search has already been used for auto-response systems. What we have done here is to make it extremely scalable as well as accurate even when multiple authors with conflicting interests are contributing domain knowledge.

An embodiment of this invention is a method comprising the steps of collecting from a plurality of independent individuals, a plurality of matching rules; associating the collected matching rules with a plurality of documents in the collection; processing the matching rules, the input query, and the collection of documents using automated means that identify those documents from the collection that match the input query; measuring a matching accuracy for the matching rules, and providing incentive means that help persuade the independent individuals to provide accurate matching rules.

A computerized embodiment of this invention consists of a means to store a collection of documents; a means to collect a plurality of matching rules from a plurality of independent individuals; a means to associate each matching rule with a document contained in the collection of documents; a means to accept an input query; an automated means to use the matching rules to compute and list those documents from said collection that match the input query; a means to measure accuracy of matching rules collected from each of the independent individuals; and a means to use the measured accuracy to reward those individuals that have provided accurate matching rules.

A form of reverse search is already used by many search-engines to present advertisements to users. An embodiment of this invention may be described in terms of advertisements as a method comprising the steps of: inviting substantially free advertisements for substantially all items contained in a collection of documents; accepting a substantially free advertisement from a person knowledgeable about a document; accepting a plurality of precise keyword matching rules from that person; accepting a search query from a user; executing the precise keyword matching rules on the search query to determine if the advertisement should be shown in response to the query; computing a trustworthiness rating for the advertisement using a database of previously collected feedback from earlier users; ranking the advertisement among others that match said query ordered by the trustworthiness rating; displaying the ranked list of matching advertisements to said user; obtaining feedback from user about relevance of each item in the ranked list of matching advertisements; and entering information related to the feedback on relevance of advertisement obtained from the user into the database of previously collected feedback.

### DRAWINGS

FIG. 1 describes the algorithm for regular search

FIG. 2 describes the algorithm for reverse search

FIG. 3 describes a user interface employed by web page publishers for specifying matching rules

FIG. 4 describes a user interface employed by searchers to conduct searches and view results

FIG. 5 describes the user interface of a help page used by a search engine

FIG. 6 describes an algorithm for reverse search that additionally incorporates incentives

FIG. 7 describes a user-interface that is used to obtain feedback from searchers

FIG. 8 describes a high speed algorithm for performing reverse search on a large collection of documents

FIG. 9 is a schematic that describes how data is partitioned among independent databases using a hashing function

FIG. 10 is a schematic that describes a computerized implementation of a high speed algorithm for reverse search

FIG. 11 is a schematic that describes a computerized implementation of a high speed algorithm for reverse search further incorporating automatic fail-over and mirroring

FIG. 12 is a chart describing the difference between regular search and reverse search in terms of accuracy and scalability

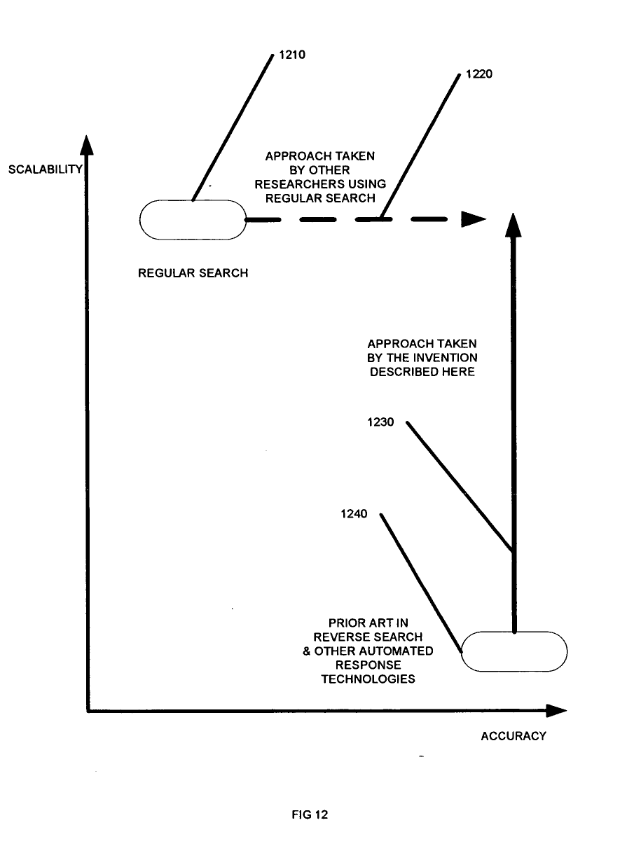

FIG. 13 is a flowchart of a particular implementation of regular search

FIG. 14 is a flowchart of a rudimentary implementation of reverse search

FIG. 15 is a flowchart of a scalable implementation of reverse search

FIG. 16 is a schematic of a computerized implementation of a scalable reverse search

FIG. 17 is a flowchart that describes using an enhanced search-engine advertising system to perform scalable reverse search

FIG. 18 is a flowchart of a scalable implementation of reverse search that further incorporates a process of guided continuous improvement

FIG. 19 is a schematic of a computerized implementation of reverse search that further incorporates a process of guided continuous improvement

FIG. 20 is a flowchart of a high speed matching system for reverse search

FIG. 21 is a schematic of a computerized implementation of a high speed matching system for reverse search

FIG. 22 is a set of rules of thumb for creating match functions

FIG. 23 depicts a match function being entered in a user-interface.

### DETAILED DESCRIPTION

Theory of Operation

Query Precision—Ambiguous Queries

Keyword searches are ambiguous. Different individuals may use exactly the same keywords to search for completely different things. Therefore keyword searches cannot have a definitive answer that can be called the ‘best possible match’.

When queries are ambiguous, the search engine's opinion on importance matters. If the search engine resolves ambiguity in one way, then all other ways of resolving the ambiguity will be drowned out. This is true even with search engines that respect majority opinion (such as Google's pagerank). The majority opinion is very effective at drowning out niche topics or minority meanings of ambiguous queries.

Query Precision—Objective Relevance

When queries are unambiguous, we can talk about the relevance of results objectively. This measure of ‘objective relevance’ is of critical importance to the concepts that will be presented later in this paper. For now, it suffices to note that natural language queries are often unambiguous. For example instead of the search keywords ‘Bill Clinton’, if the user enters ‘What did Bill Clinton eat for breakfast when he was President?” then we may reasonably talk about an objective measure of relevance for the search results.

Query Precision—Precise Queries have Precise Answers

When a query is precise, it is possible to answer it precisely. In other words, the set of responses to a precise query can be objectively ranked according to their relevance. The most relevant response is the best possible answer that the user can get from the searched document collection.

Reverse Search—A Precise Response Algorithm for Precise Queries

Much of the work that has been done so far on precise responses has been in automated response systems. These are usually used in automatic e-mail answering, automated web self-help, technical support, and customer service applications. When a user enters a query (often using natural language) these systems return a highly relevant response. There are many technologies that are used to implement automated response systems, and one of the most effective is matching keywords against the query. Building further upon this concept brought us to the idea of ‘reverse search’ presented below:

Reverse Search—Introduction

In the usual keyword search performed on the web, a user enters keywords. The engine then retrieves documents that contain those keywords.

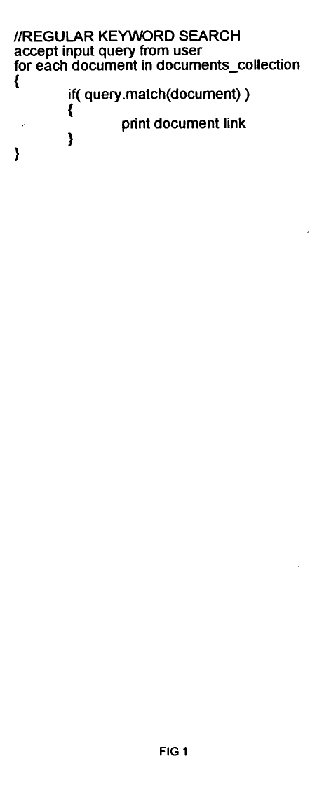

The regular keyword search algorithm may be represented as shown in FIG. 1.

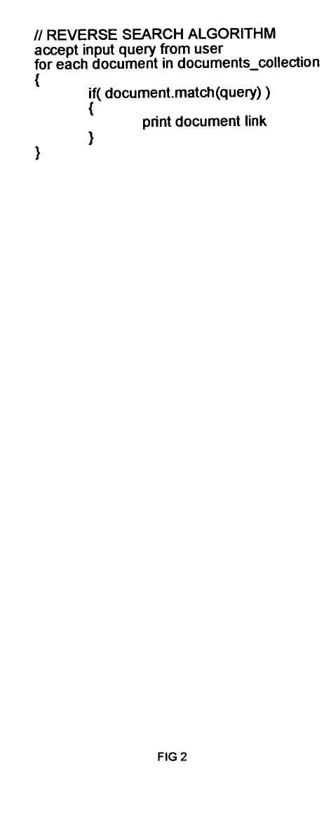

In this case, query is implemented as an object that contains a ‘match( )’ method to determine if the keywords are present in the document object that is passed in as a parameter. Instead, consider the algorithm in FIG. 2.

The only difference is that the ‘match( )’ method is now part of the document object instead of the query object. Not much difference? After all the method is likely to behave the same way right? Not quite!

When the match( ) function is part of the document object, it is possible to have a different match( ) function for each document! Furthermore, instead of having to deal with a parameter that is a few pages long and of complex structure (with links, pictures and tables) the match method in the document object only has to deal with a relatively short query of perhaps 10 to 15 words. This difference is critical.

When the match method is part of the document object, it can be relatively simple and yet exceptionally accurate. An example will help clarify this concept. First we will consider how a regular search operates, and then how the reverse search works.

Regular Search:

Suppose the user enters the query: “How do I build a pyramid made of marble and glass?”. In a regular search, the match( ) function is part of the query object (or a global function unassociated with any object). Stop for a moment to consider how such a query function may be implemented. The problem is indeed hard. A simple mechanism will be to implement query.match( ) as follows:

bool query: :match(document_type doc)
{

if(doc contains the keywords in query)
{

return true;

}
else
{

return false;

}

}

This is a simple keyword search. As we know, it is one of the weakest ways of searching for information. A document that describes how to make a glass marble with a pyramid pattern inside it will match the query as well as a document that describes how to make pyramids of marble and glass.

Improving the query function is not easy. We may develop heuristics based on the number of citations and other analysis of the contents of the document parameter, but the results are not always satisfactory as we have seen earlier in this paper.

It is worth pointing out that the reason why it is so difficult to implement a truly effective query.match( ) function is the complexity of the parameter that is passed to it. The parameter in this case is a document, and a document contains video, sound, links, tables, formatting, sentences, paragraphs, headings and other complex structures. It is often many pages long. Machine analysis of its semantics is almost impossibly difficult.

Reverse Search

In a reverse search, the match( ) function is part of each document object. The parameter to this function is a query that is typically less than 10 words. The parameter will not have headings, formatting, tables, colors, media or paragraphs. We may have a different match( ) method attached to each document.

Because the document.match( ) function has to analyze such a small string, it is relatively simple to build a match function that works very well for that particular document. Consider a document that describes how to build glass marbles with pyramid designs inside them. There are only a small finite number of ways in which this information may be requested by a searcher. Some examples are:
“How do I build marbles with pentahedral designs?”
“I want to manufacture marbles with pyramid patterns”
“How can I make marbles with pyramidal shapes in them?”
“I wish to design marbles of glass with a small pyramid at the center”

Typically there are less than 50 or so distinct ways of asking a query for which this document will be an appropriate response.

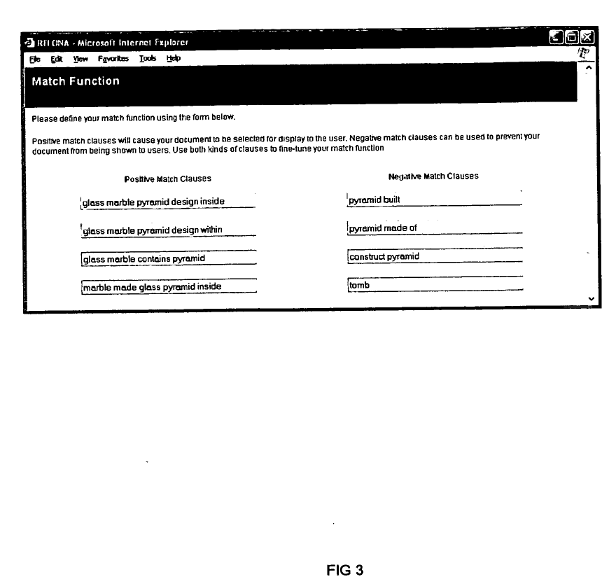

How do we program a match( ) function to recognize these queries? We can use brute force. Since there are only a small finite number of distinct possibilities, brute force works well. For example, we may implement a match( ) function for this document as shown in FIG. 3.

Notice that a match( ) function can usually be specified in terms of word sequences. It is not necessary to write ‘code’ using a programming language. A word sequence is sequence of keywords. The idea is that if the words appear in the user's query in exactly the same order (but with possibly some other words added in between) then the word sequence matches the query. For example the word sequence “glass marble pyramid design inside” will match the query “How can I make a glass marble with a pyramid design inside it?” The same word sequence will also match the query “How can you construct glass marble for children to play, so that it has a pyramid design inside the glass?”

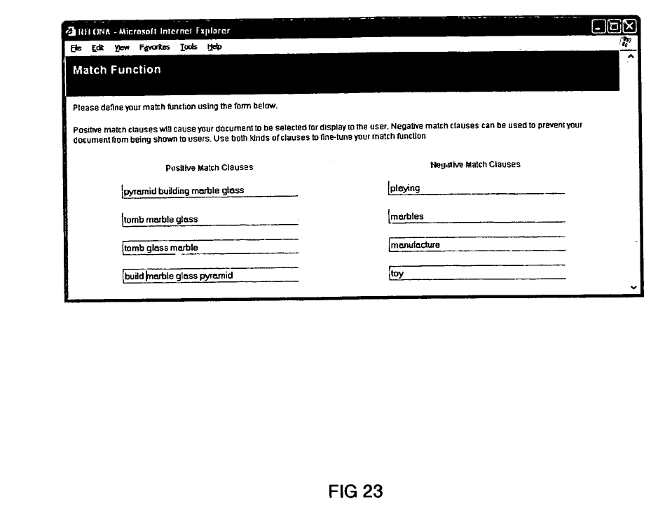

A document that describes how to build pyramids of marble and glass may implement its match( ) function as shown in FIG. 23. A query that asks: “How do I construct a pyramid building made of marble and glass?” matches the second document (FIG. 23), but not the first (FIG. 3).

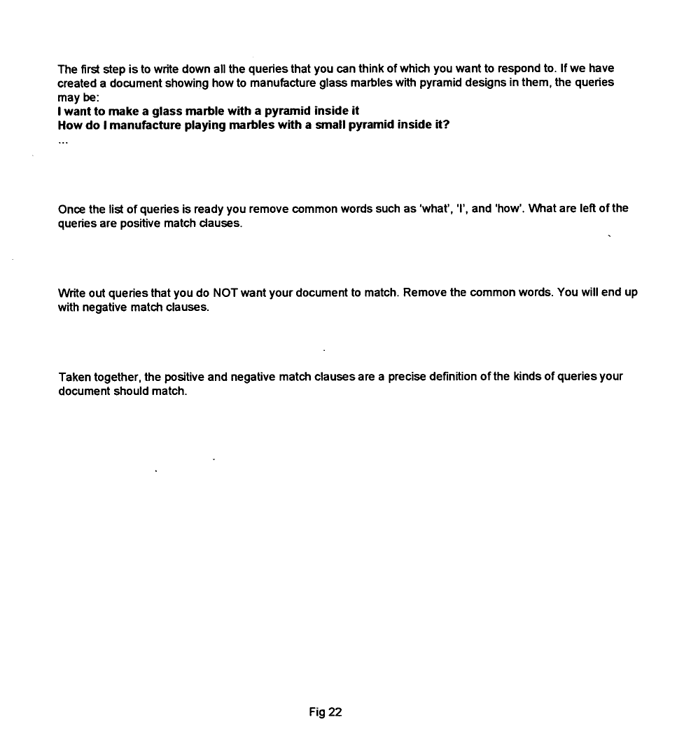

How do you write match functions? A quick heuristic procedure (these are just rules of thumb, there is no fixed procedure for writing match functions) is shown in FIG. 22.

The difference between a regular search and a reverse search is startling. While a regular search couldn't distinguish between two different concepts expressed using similar words, the reverse search has no problem. Notice that such precise distinctions are possible in reverse search because the parameter passed to the match function is so small and simply structured. Accurate analysis of short questions is fairly straightforward. On the other hand, regular search needs to analyze arbitrarily complex multi-page documents.

The match functions we presented in the last section are fairly simple to implement. The only effort involved is in choosing the right word sequences. Compared to the effort involved in authoring a document for the web, this effort is trivial.

In section 4.a. we have established that if the match( ) functions are perfect, then the results returned by reverse search will be nearly perfect. See item 1 in the outline sheet.

Historical Note: The idea of analyzing the query string (as opposed to analyzing the document text) has generally been used in technology for building automated response systems for customer service and tech-support. When customers send e-mail queries or when they use a web-based self-service system, highly relevant responses need to be provided. In fact, the advanced algorithm described here was originally developed for the purpose of collaboratively building a very scalable automated customer-service system (auto-response) with multiple authors. The resulting algorithm turned out to be so scalable that it applies to web search as well.

Reverse Search—Continuous Improvement & Convergence to Perfect Relevance

We have already seen in the last section that reverse search can perform brute-force analysis of the meaning of a query. In other words, it can make very fine distinctions in meaning without resorting to complex heuristics.

As long as someone develops a perfect set of match( ) functions for each document, a reverse search can achieve perfect relevance—Every query that has an answer in the collection of documents being searched will be answered correctly. The problem is that the first attempt someone makes at developing a match( ) function is not likely to produce a perfect match function.

To solve this problem we use feedback. If the developer creating a match( ) function is given ongoing feedback about which queries it missed and which ones it incorrectly matched, then the developer can work to correct the match function. In other words, if the developer knows what changes to make and is committed to a process of continuous improvement, then the match( ) function will converge to near-perfect behavior.

For example, the match functions that we developed for the marbles page and the pyramid page may produce incorrect results for some query like: “Why did pyramid builders play with marbles?”. But through using feedback about the wrong results, it is a simple matter to fix both the match( ) functions.

Improving the match( ) functions is straightforward. It will happen if sufficient incentive exists and if proper feedback is provided. These two conditions will be discussed in subsequent sections of this paper.

Reverse Search—Leveraging Highly Specific Domain Knowledge

It has been known for a long time that in AI-like knowledge based systems, the specificity of domain knowledge is more important than the sophistication of the knowledge-analysis engine. For example, if we are building an AI system to help an ant-robot march across sand, it is useful to know about the general physics of motion of Newtonian bodies. But it is more useful to know very specific information about how a grain of sand behaves when the ant-robot steps on it.

In the case of search, our algorithm captures domain knowledge that is highly specific to each document. Contrast this approach with a mechanism like the Semantic-Web that relies on a sophisticated reasoning system and a generalized knowledge base.

Reverse search uses a vast quantity of highly specific domain knowledge. So it achieves high accuracy even though the algorithm that operates on the knowledge is relatively simple.

Benefits of Applying Reverse Search to the Web—Accuracy

As we have already seen, reverse search with appropriate feedback mechanisms to facilitate continuous improvement will converge to the ‘best possible’ results.

Benefits of Applying Reverse Search to the Web—No More Guessing Keywords

Keyword search systems usually expect the user to guess the words that might have been used in the desired document. With reverse search, the ‘guessing’ is done by the person who writes each document's match function. So users of reverse search have a better experience.

Benefits of Applying Reverse Search to the Web—Natural Language Queries

Reverse search accommodates natural language queries. Natural language can be used to specify exactly what the user wants, so ambiguity may be avoided. Most important, natural language is supported without using complex language understanding technology, so the algorithm is reliable and scalable.

Benefits of Applying Reverse Search to the Web—Deterministic Algorithm

Reverse search is deterministic. Unlike neural networks, heuristics, or fuzzy learning, this system is predictable and easily scalable.

Problems with Prior Art in Reverse Search

Prior implementations of reverse search (usually in customer service and auto-response applications) have suffered from a number of problems that prevent their use in searching the web.

Problems with Prior Art in Reverse Search—Spamming and Biased Match( ) Functions

If content-owners write match( ) functions, they have a strong incentive to write biased functions so that their content is shown more often (than is appropriate) to searchers. Later sections of this specification will demonstrate features in this algorithm that protect against such spamming.

Problems with Prior Art in Reverse Search—Scalability of Existing Reverse Search Algorithms

Existing reverse search architectures are not very scalable. In order to handle billions of pages, we need a highly scalable system with low computational overhead. An architecture (called RAPID) specially developed for this purpose will be described in later sections.

Successfully Applying Reverse Search to the Web—Splitting Responsibility for Feedback & Improvement

Perfect Reverse Search requires (1) someone willing to develop and continuously improve a match function for each document and (2) unbiased feedback about matching errors. There is no necessity that both of these be obtained from the same individual. On the contrary, there is good reason to keep these two responsibilities completely separate. There are three kinds of players in web search. One is the community of searchers who use search engines everyday to find information on the web. The second are the search-engine operators who develop, support and maintain web search engines and directories. The third is the community of web content producers, web site owners and web page authors. Of these three players, the searchers and search-engine operators are generally accepted as being ‘unbiased’. The third group—the community of web page owners—has a vested interest in giving their web content as large an audience as possible.

Until now, any effort that required unbiased input has been contributed by searchers or search-engine operators rather than content authors. For example, developing a web directory is labor intensive. Some directory owners have themselves hired thousands of editors to find and classify content (such as Yahoo). Some others have tried to develop a voluntary community of unbiased searchers who contribute content (the open directory project). The trouble is that though communities of searchers and search-engine operators are unbiased, they have limited resources and limited incentive to contribute. When faced with the vastness of the web, input from purely unbiased sources is not sufficient.

The third group whose input has not been solicited so far—the content-owners—have incentive to make sure that their content is seen by a large audience. They will contribute effort if it will help their cause. Unfortunately, until now it has been impossible to build an unbiased search system using biased input from content-owners.

This algorithm demonstrates how biased input from content-owners may be coupled with unbiased feedback from searchers to create an unbiased reverse search system. Specifically, we ask content-owners to provide match( ) functions. We use these match( ) functions to compute search results. Then we ask searchers to provide feedback about the relevance of the links that matched their query. We use this feedback to either increase or decrease the ‘trustworthiness’ of individual web sites and their match( ) functions. A trusted match( ) function gets greater weight when computing responses. An untrusted match( ) function will be given lower importance and the document it is attached to will be shown infrequently. This feedback mechanism keeps web site owners honest and aligns their interests with that of the searchers.

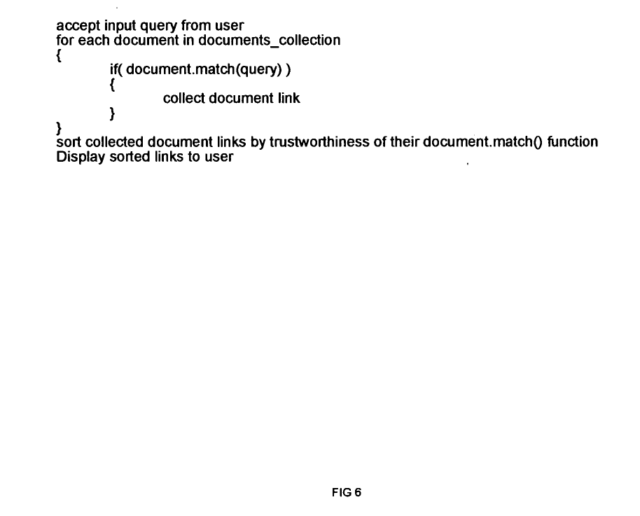

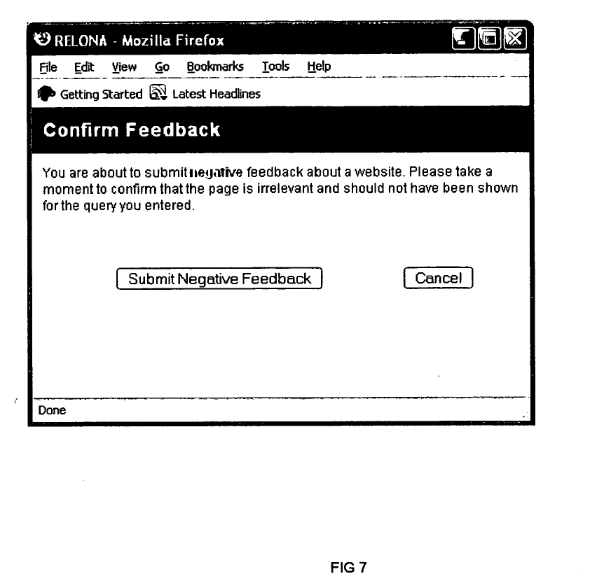

A reverse search algorithm that incorporates trustworthiness is shown in FIG. 6. A user interface for collecting feedback is shown in FIG. 7.

Notice that we are collecting feedback about the trustworthiness of match( ) functions. We are not asking searchers about the ‘importance’ of the web sites, their ‘popularity’, or their ‘quality’. By using trustworthiness as the measure, we are rewarding honest match( ) functions—ones that match only when their content is highly relevant to the query.

This feedback mechanism plays two roles. On one hand it ensures that match( ) functions converge to trustworthy behavior over time. On the other hand it provides information about matching errors that is used to continuously improve the match functions.

Successfully Applying Reverse Search to the Web—Persuading Content Owners to Invest Effort Through Incentives for Continuous Improvement

Now that we have decided to accept contributions from website owners, the question arises: How do we persuade a substantial majority of the content-owners on the web to invest effort in developing match( ) functions?

To answer this, we will begin by looking at the interests that drive content owners. We may safely assume that content owners who have published documents on the web want their content to be seen by as many people as possible. After all, that is why they published the content in the first place! Some content owners are so eager to give their pages visibility that they are willing to pay to get visitors—they place advertisements on search engines, buy banners and pay to be listed in directories. Others go to great lengths to alter the position of their websites in search engine results.

Since website owners want their content to be visible, it is reasonable to expect that if they are offered “advertisements on a search engine for free” they are likely to be very interested. The only catch is that they have to write an honest match( ) function to qualify for the “free advertisement”!

Will they take this offer? Considering that a typical match( ) function can be developed in about 10% of the time it would have taken to write the page content, we expect that most website owners will eventually contribute match( ) functions for the “free advertisements”.

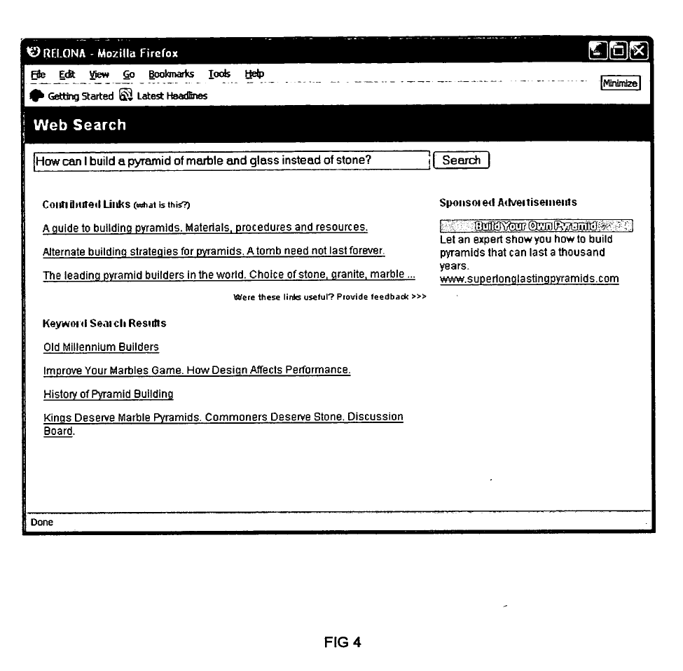

Having collected applications for the free advertisements, we don't suggest that the search-engine place advertisements for free. Instead, the search-engine provides a new category of search results as shown in the FIG. 4.

The ‘contributed links’ are clearly marked, but are also placed prominently. These are the so-called “free advertisements” offered to website owners. We are not suggesting a bait-and-switch tactic to fool the website owners. We are merely pointing out that by focusing on the similarities between placing search-engine advertisements and creating match( ) functions, website owners may be more easily persuaded to contribute match( ) functions.

Furthermore, the links found through the match( ) functions are shown very prominently, so for practical purposes, this really is free advertising for website owners. Their only additional responsibility is to ensure that the match functions are very relevant—as otherwise their trustworthiness rating will suffer.

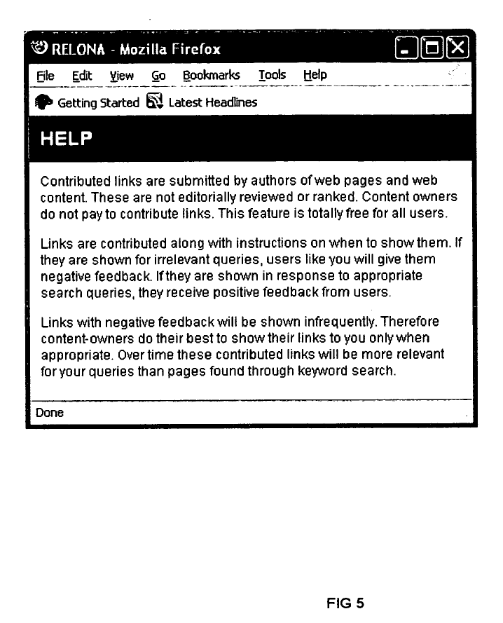

Writing match functions may actually be easier than using many of the search-engine advertising systems that are now available. Website owners have enthusiastically embraced these advertising systems, so it seems reasonable to believe that they will also be willing to write match functions—especially since it will cost them nothing. The “What is this?” link connects to a help page that explains to searchers that these are not paid-for advertisements, but are instead the results of a better search algorithm. It also invites users to add their own web content as shown in FIG. 5.

At this point, the astute reader might have noticed a problem. We have so far discussed reverse search in the context of natural language queries. How can reverse search be used with ambiguous keyword queries entered into existing search engines?

There really is no problem. When asking the website owners to provide a match( ) function, we ask for two sets. One set is for unambiguous queries and the other for keywords. When a user enters a query it is easy to determine if it is a natural language query or a keyword query. If there are certain indicator words such as “what”, “how”, “I”, etc. we treat it as a natural language query and use the match( ) functions collected for unambiguous queries. If there are no indicator words like “what” and “how”, then we treat it as a keyword query and use the alternate match( ) functions. The same algorithm can be used for both situations.

The match( ) functions for keywords will slowly become obsolete as searchers begin to favor precise natural language queries over keyword queries. But during the transition period (which may run to years) having both sets of match functions is useful.

Efficient Implementation

Efficient Implementation—Requirements

An architecture for searching the entire web must be highly scalable. What does this mean in practical terms?
Partitioned Databases: It will not be possible to store information about tens of billions of pages in one database. Therefore, the data will need to be split among different databases. But merely splitting the data is not sufficient. There should be no dependencies between data in different databases, as otherwise the overhead of synchronization will reduce scalability.
Parallel Algorithms: We can reasonably expect 100 million queries to be entered every day. To handle such volumes, the algorithm will need to run on a parallel processing computer, a distributed system or a grid computer. To run efficiently on a parallel processing computer, the algorithm itself must be highly parallelized.
Relatively Small Queries: It is sufficient if the system restricts query lengths to some small number like 15 or 20 words. It is unlikely that users will enter longer queries.
Database Redundancy: For ease of maintenance, it should be possible to shutdown an individual database for upgrades without affecting performance of the entire system. This will also make it easy to add match( ) functions and make updates to data.
   Efficient Implementation—Redundant Array of Partitioned Independent Databases

In this section, we present a highly efficient algorithm for performing reverse searches.

We assume that content-authors have already provided us with match( ) functions for their documents. Match functions consist of clauses. Each clause is a word sequence. There are positive match clauses and negative match clauses. Each positive match clause is independently stored and indexed in a database. We don't need to index negative clauses for reasons that will become apparent later. Negative clauses are only retrieved as part of the match functions.

When a user enters a query, we need to find the match function that matches that query. As a first step we find the positive match clauses that match the query. Once we have the positive match clauses, we use foreign keys in the database to collect the entire match( ) functions.

How do we find the positive match clauses that match a query? Given a query, we enumerate all the possible positive match clauses that might match the query. If the query has ‘n’ words, we need to enumerate all the possible word sequences that may be made from that query. This is the same as enumerating all the subsets that may be made from the words in the query. We know from combinational mathematics that there will be nC0+nC1+nC2+ . . . +nCn subsets. This sum of combination expressions evaluates to 2\hat{ }n.

An example will illustrate this principle. The query “who am i?” has 3 words. There are 8 subsets possible: {“who”,“am”, “i”}, {“who”, “am”}, {“who”,“i”}, {“am”,“i”}, {“who”}, {“am”}, {“i”}, { }. These subsets (except the null subset) correspond to all [(2\hat{ }n)−1] of the possible match clauses that might match the query:
positive_match_sequence(“who”,“am”,“i”)
positive_match_sequence(“who”,“am”)
positive_match_sequence(“who”,“i”)
positive_match_sequence(“am”,“i”)
positive_match_sequence(“who”)
positive_match_sequence(“am”)
positive_match_sequence(“i”)

Once we have enumerated all the possible positive match clauses, we simply look them up in the database to see which ones belong to real match( ) functions. Next we retrieve those match( ) functions from the database and evaluate the query against them to confirm the match. The documents that correspond to the matching match( ) functions are sorted by descending order of trustworthiness and shown to the user.

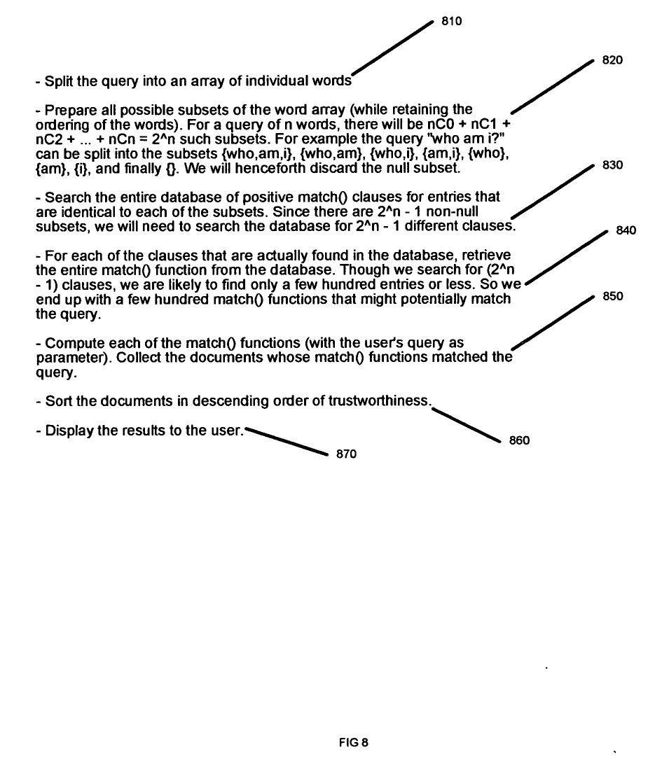

The algorithm is shown in FIG. 8.

An example will make the sequence of steps clearer. Suppose there is a document about self-awareness. The author believes that the document should match queries like “who am i?”. The author does not want to match queries like “who am i becoming?” So the match function is written as:
positive_match_sequence(“who”,“am”,“i”)
negative_match_sequence(“becoming”)

The document will now match a query like “who am i to dispute this?”, but not queries like “who am i becoming?”.

The match function has only one positive clause:
positive_match_sequence(“who”,“am”,“i”)

This clause is stored and indexed in the database as “who_am i”—a string of characters stored in an off-the-shelf RDBMS.

When the user enters “who am i to dispute this?, we reduce the query to all possible subsets as shown in steps 810 and 820. There will be 2\hat{ }6=64 subsets in this case. One subset is null, so we will search for 63 subsets in the database. Of these 63, one subset is {“who”,“am”,“i”}. To search the database for this subset, we search the RDBMS for the string “who_am_i” as shown in step 830. Since the RDBMS uses efficient indexing, this string will be found in logarithmic time. Once the “who_am_i” is found, the database gives us (through foreign keys) the entire match( ) function, the trustworthiness rating, and the url of the document shown in step 840. The entire match( ) function includes not only positive clauses, but negative clauses as well, so we need to fully evaluate the match function to confirm that the user's query matches it.

When we evaluate the entire match( ) function in this example, we find that the query matches it. So we add the document url to the result set as shown in step 850. When the result set is complete (after performing searches on all 63 subsets), we sort it in order of trustworthiness and then display it to the user as shown in steps 860 and 870. Note that each of the 63 searches may return zero or more positive match clauses. Each returned match clause may belong to one or more match( ) functions. Not all of these match( ) functions will be found to match after they are fully evaluated (taking negative clauses into account). Therefore, the number of documents finally retrieved and matched is not related to the number 63 in any way.

So far we have performed the search from a single database. But for scalability, we would like to partition the data across multiple databases.

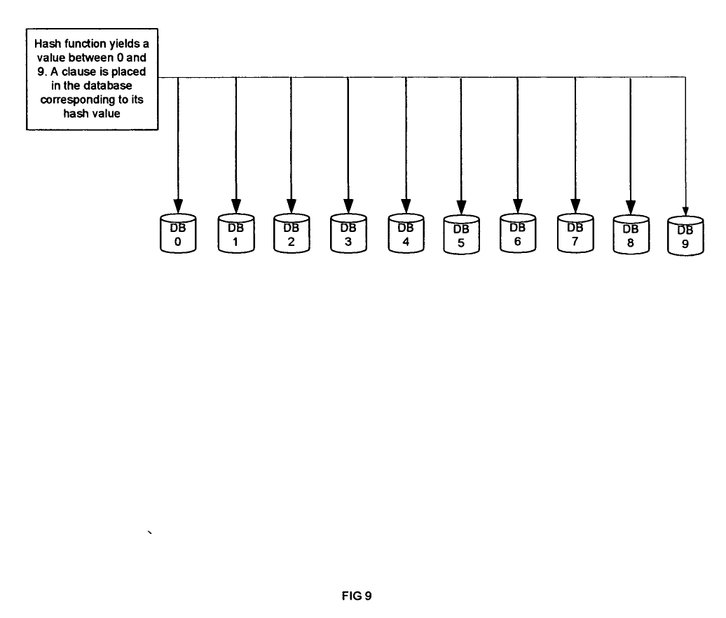

This is actually quite simple. The first step is to create a hash function. The hash function takes as parameter a match clause represented as a string (like “who_am_i”) and produces a number between (say) 0 and 9. Since the hash function can produce 10 different codes for any clause, we use it to split the clauses among 10 different databases as shown in FIG. 9.

The idea is that a clause whose hash code is 1 goes into database 1, the clause with hash-code of 2 goes into database 2 and so on.

When we search for the clause/subset, we first compute the hash function on each clause to determine which database we should connect to. Next we connect to that database and perform our search for clauses/subsets.

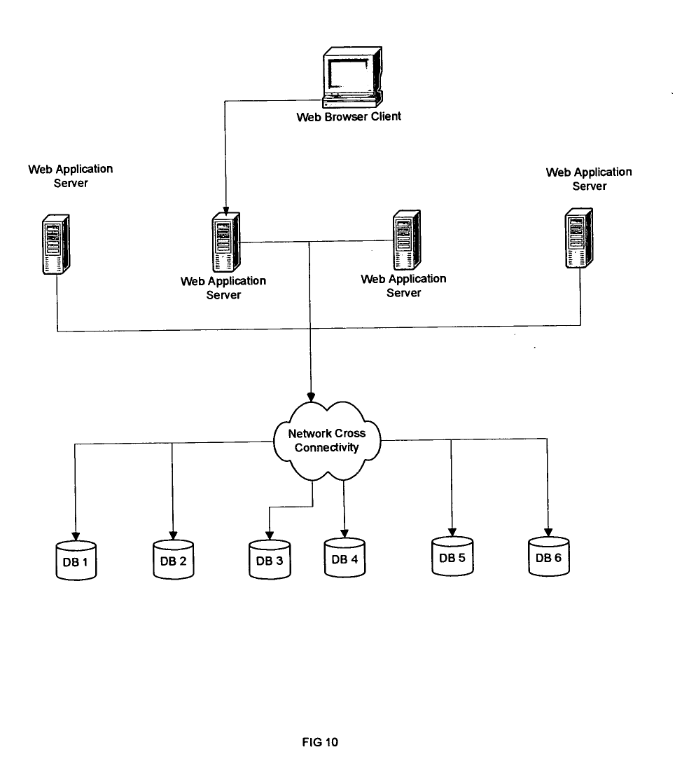

FIG. 10 shows how the entire system works.

The search query is entered on a web page and submitted to a web application server. For scalability, there is a farm of web application servers, and the query is sent to any one at random.

The application server splits the query into n words and prepares the 2\hat{ }n−1 subsets. For each subset, it computes the hash function to determine the database to connect with. It then performs a database query to find out the match( ) functions for that subset/clause.

The application server collects all the match( ) functions it finds for all the subsets, computes each of the match( ) functions and finally computes the list of all documents whose match( ) functions match the query.

These document URLs are sorted according to trustworthiness and then displayed to the user.

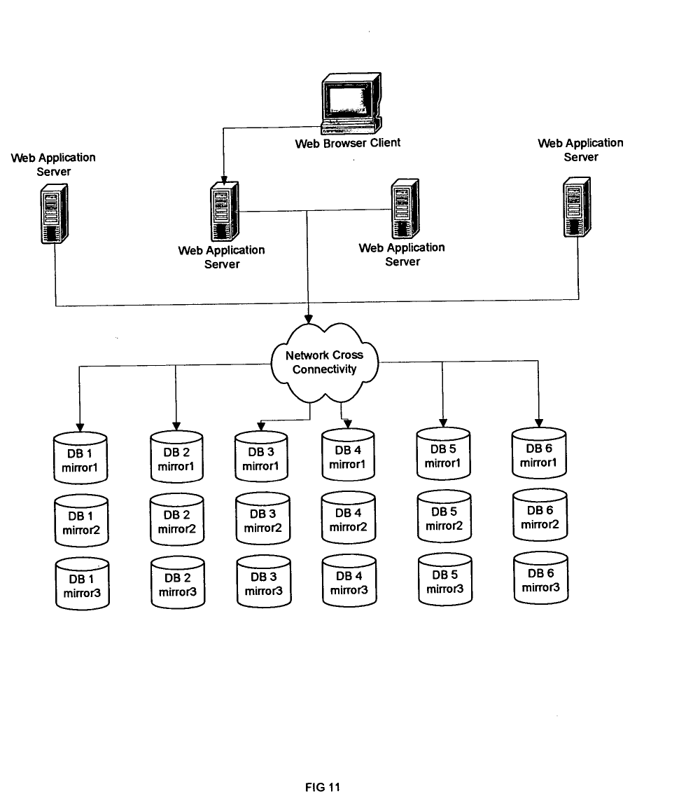

For further scalability, each partitioned database has one or more mirrors as shown in FIG. 11. The application server connects to any one of the mirrors (whichever is available) at random. Any of the mirrors can be shutdown for maintenance without affecting system performance.

As you can see, the RAPID architecture is built upon standard off-the-shelf software and hardware components. The data-stores are standard relational databases. The application servers may be .NET or J2EE.

Since the web client connects to an application server at random, the app-server farm may be scaled up simply by increasing the number of available application servers. Since a hash function is used to partition the data among independent databases, the database array may be scaled up simply by altering the hash function and having it return a larger range of values.

Each of the 2\hat{ }n−1 queries run by the app-server is completely independent of the others. So there is no synchronization necessary. The application server can run on a multithreaded multi-CPU machine and all CPU resources will be automatically used. The databases are also completely independent of each other since there are no cross-references between clauses.

For easy maintenance of the databases, we use mirrors. Any of the mirrors may be shutdown and restarted without affecting system performance.

The only thing here that doesn't scale well is the length of the query. If a query has ‘n’ words, we need to search the databases for ((2\hat{ }n)−1) subsets. This is exponential growth. Fortunately, the queries entered by users are usually small. Almost all queries can be expressed with just 15 words or less. By eliminating stop words, the total number of subsets to search can be reduced still further. Finally, for very expensive queries, searchers may be asked to pay for the service.

If an exceptional situation arises where very long queries have to be matched, some alternatives are available. We can search for a primary query, retrieve relevant match( ) functions and then run the match( ) functions against the longer secondary query. We don't expect it to be necessary to run longer queries, so such techniques will not be discussed further in this paper.

Efficient Implementation—Future Improvements

The algorithm presented here converges to near-perfect results. In some sense, this is the best possible algorithm and its results cannot be substantially improved. However, there is certainly room to improve the performance of the implementation and the manner in which match( ) functions are specified. Automated tools that help to reduce the burden of developing match( ) functions will help content-owners publish more information at lower cost.

Preferred Embodiment

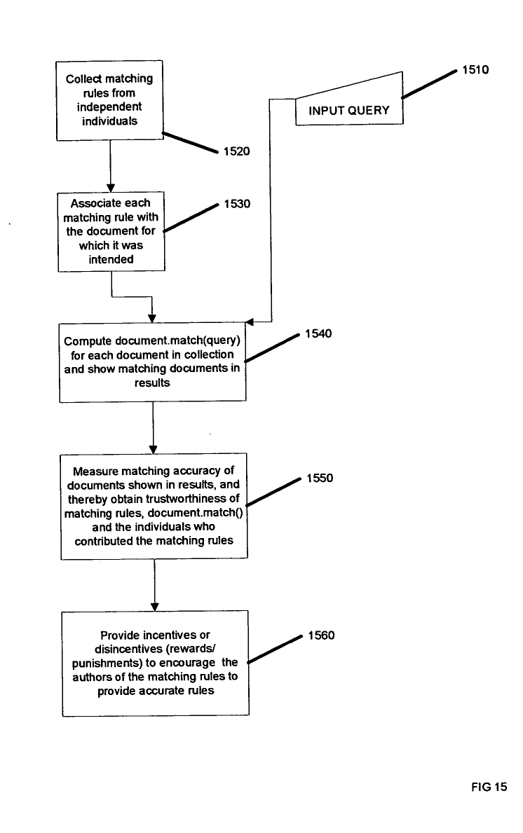

An embodiment of this invention is described in FIG. 15. A query is accepted from a user in step 1510. To find documents that are to be shown in response to the query, we collect matching rules from the authors of these documents as shown in step 1520 and associate these rules with their corresponding documents in step 1530. In step 1540 we identify the document whose match-functions match with the input query and show the identified documents in a results page. In step 1550 we solicit feedback from search-users about the results we have computed. This feedback helps us measure the trustworthiness of the matching rules used to compute each item in the results page. In step 1560, we keep a cumulative record of the trustworthiness of each match-function and reward trustworthy match-functions with better placement on the results page during subsequent searches.

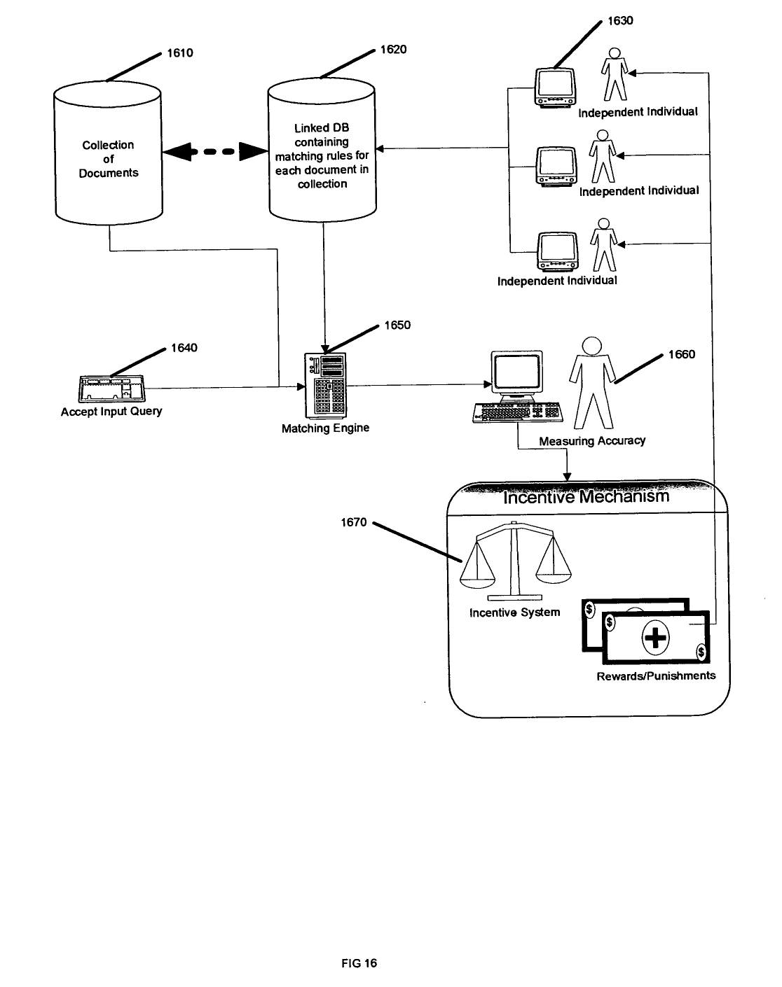

A computerized implementation of this method is shown in FIG. 16. The matching-rules collected in step 1520 through terminal 1630 are stored in data-store 1610. The rules captured in step 1530 are stored in data-store 1620. The input query captured in step 1510 is entered through a terminal 1640. The matching step of 1540 is performed by a server machine 1650. Feedback used to measure accuracy in step 1550 is obtained through the terminal 1660. The incentive system 1670 implements step 1560.

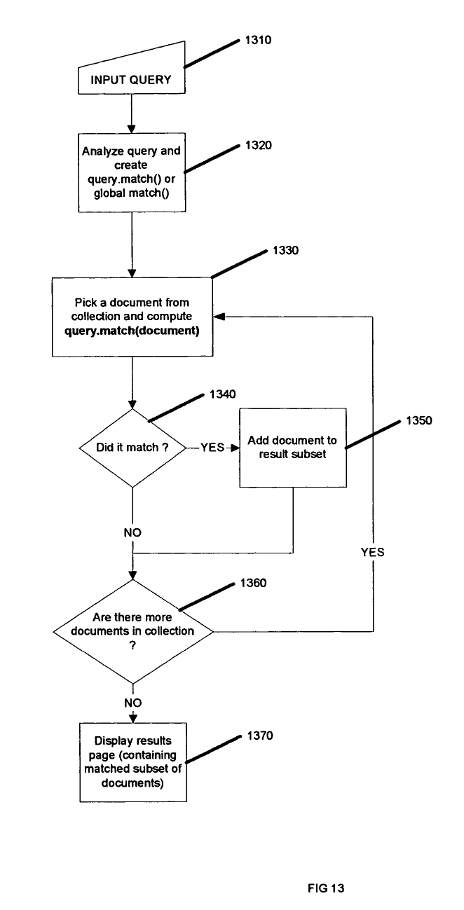

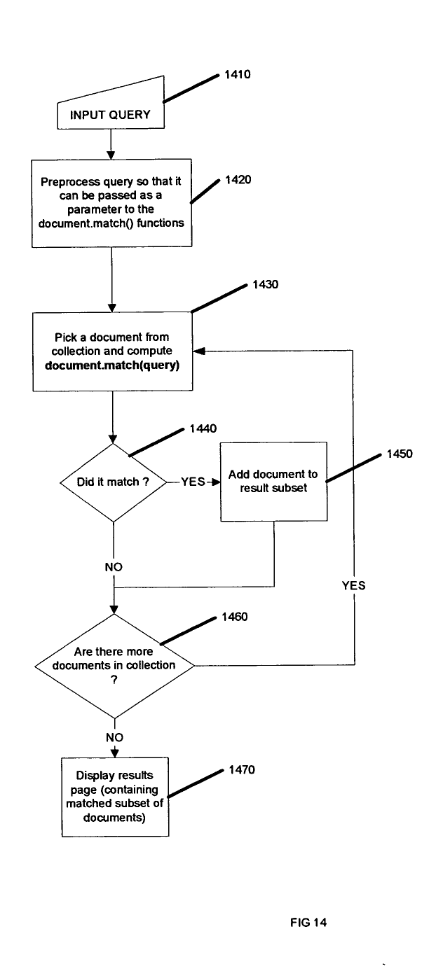

The step 1540 of determining which documents match the input query is elaborated for the general case in FIG. 14. Contrast step 1430 with 1330 in FIG. 13 to understand the core difference between regular search (described in FIG. 13) and reverse search (described in FIG. 14). The method described in FIG. 14 works for the general case when match functions are arbitrary scripts that are computationally equivalent to Turing-Machines. In step 1410 an input query is accepted from a search-user and in step 1420 it is processed so that it may be passed as a parameter to the match functions. In steps 1430, 1440 and 1460 we iterate through the documents in the collection and run each of their match-functions on the query. If it matches, we add it to the result-set in step 1450. Finally the collected results are shown to the user in step 1470.

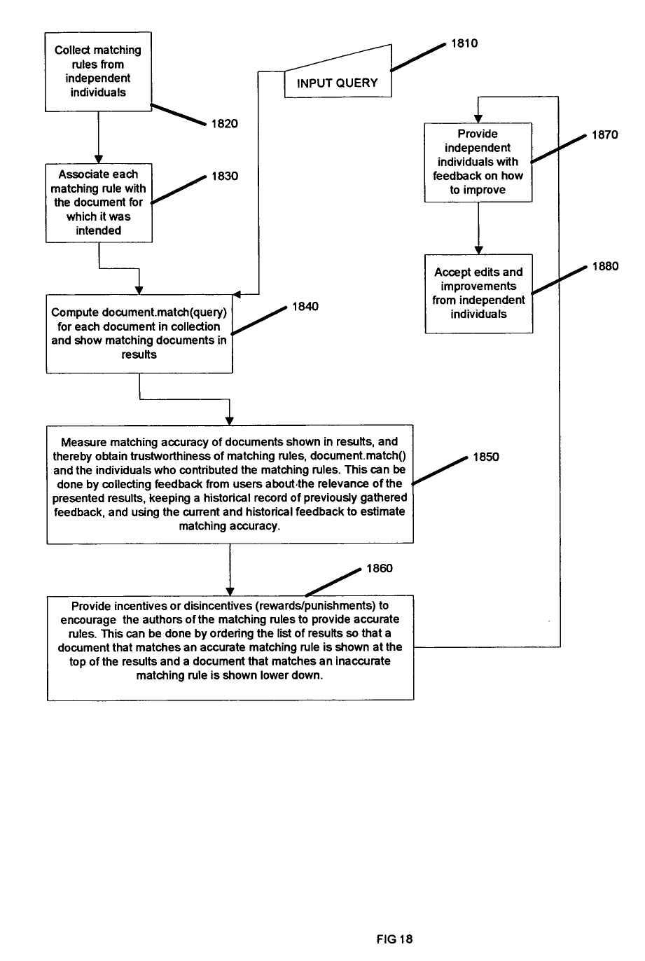

To ensure that authors of documents are able to correct any mistakes in their match-functions, we add a few more steps as shown in FIG. 18. Whenever we find (in the measuring step 1850) that some match function is inaccurate, we follow step 1860 with step 1870 that provides concrete guidance on how to correct mistakes. In step 1880, we accept the corrections. This fosters a process of continuous improvement that eventually removes inadvertent inaccuracies in match-functions.

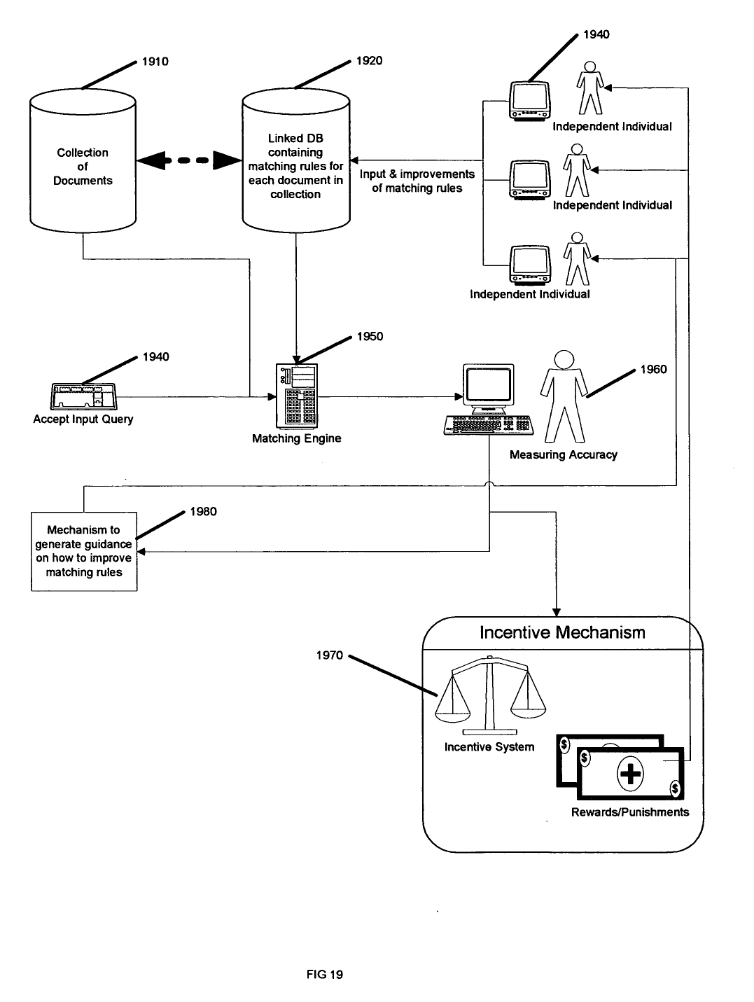

In FIG. 19, the schematic element 1980 implements step 1870. Step 1880 is implemented by the terminal 1940.

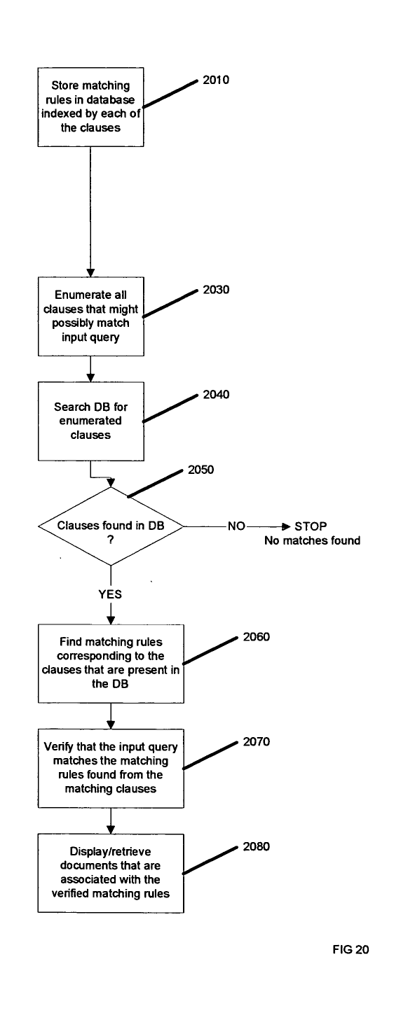

For maximum accuracy of the search system, step 1540 is implemented as shown in FIG. 14. The method of FIG. 14 can deal with arbitrarily complex Turing-Machine equivalent match functions. However, in many situations, we are willing to trade-off accuracy for speed. In such situations we implement step 1540 as shown in FIG. 20. Here we restrict match functions to consist only of positive and negative match clauses as shown in FIG. 3. Such clauses are sufficiently powerful for most applications. In step 2010, we store match-functions in a database indexed by the positive match clauses. In step 2030, we enumerate all the positive match clauses that might possibly match the input query. If there are ‘n’ words in the query, there may be upto an order of 2\hat{ }n possible match-clauses enumerated. In steps 2040, 2050 and 2060 we search through the database and identify all those match functions that have at least one of the enumerated match clauses. Thes match functions represent potential matches for the query, but we are yet to confirm a match using the negative match clauses. In step 2070 we filter out those match functions that fail because of the negative clauses. In 2080, we proceed using the final results.

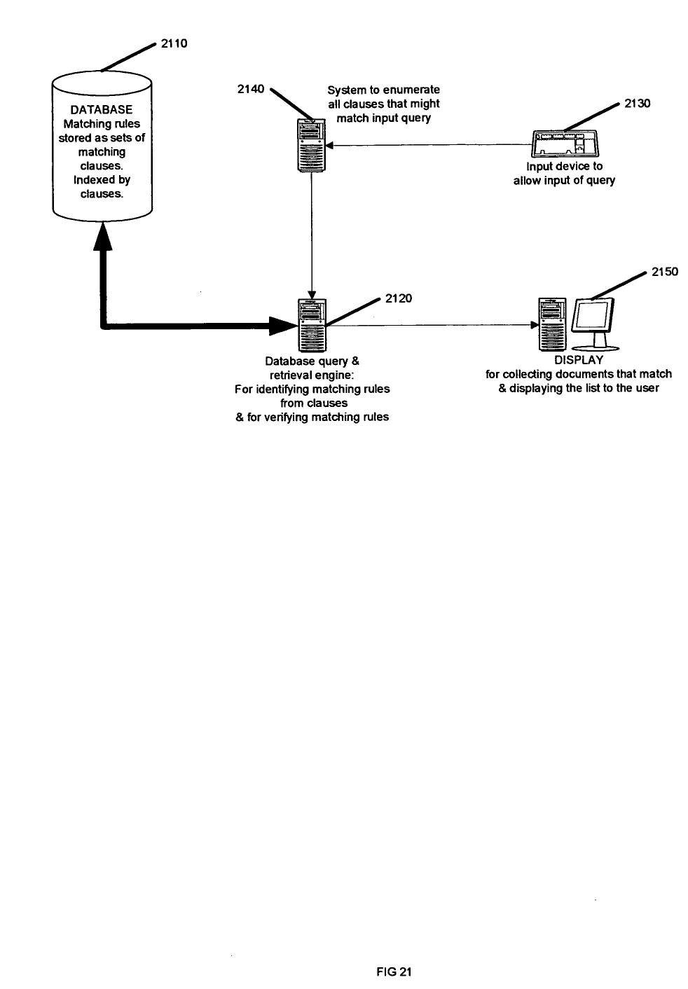

Step 2010 is implemented as shown in FIG. 21 by a database 2110. Step 2030 is implemented by server 2140. Steps 2040, 2050, 2060 and 2070 are implemented by the machine 2120. Step 2080 is implemented by display means 2150.

In practical terms, the user interface of step 1510 looks like FIG. 4. The interface for step 1520 looks like FIG. 3. The interface for collecting feedback in step 1550 looks like FIG. 7.

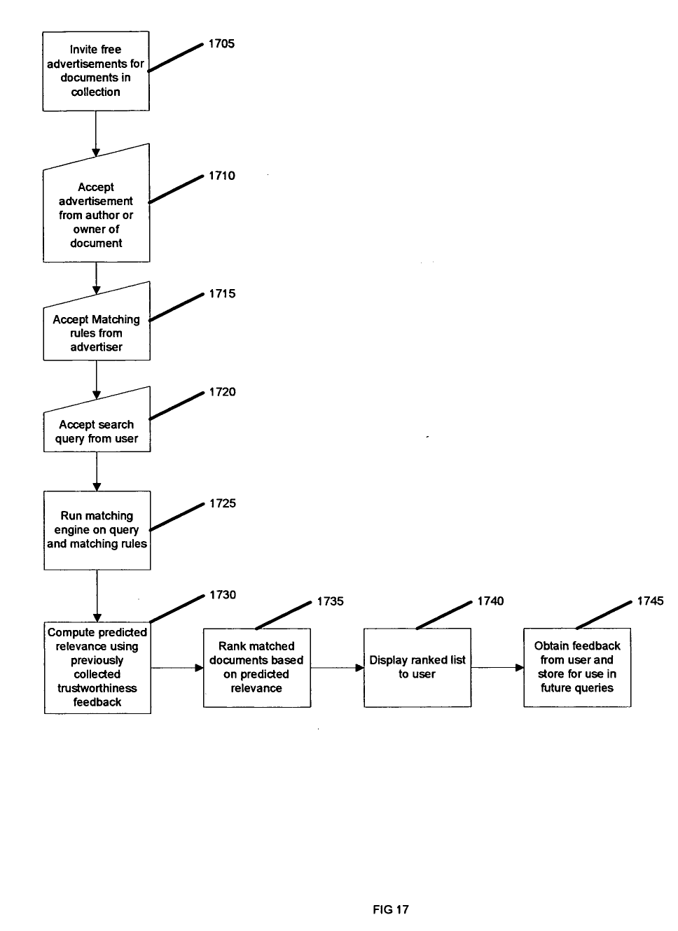

According to an alternate embodiment of the invention, a search-engine advertising system may be modified so that it produces very highly relevant search results (instead of advertisements). In FIG. 17, step 1705 is to invite all the authors of documents to submit free advertisements for their own content. We call these free advertisements, but they are essentially matching functions. In step 1710, we accept a link to content and in step 1715 we take the matching functions for the content. In step 1720, we take an input query from a search-user. In step 1725 we find content that matches the query. In step 1730 we determine trustworthiness of the matched content and in step 1735 we reward trustworthy content with better placement on the search results page. In steps 1740 we display results to the user and collect measurements of trustworthiness for future use in step 1745. The key here is that the advertisements are free and the primary responsibility of the content-provider is to submit high-quality match-functions for their own content. We also invite everyone to submit match-functions, not just those willing to or able to pay.

1. A method of indexing a collection of documents and identifying a subset of documents that match an input query comprising
(a) collecting from a plurality of independent individuals, a plurality of matching rules,
(b) associating said plurality of matching rules with a plurality of documents in said collection,
(c) processing said plurality of matching rules, said input query, and said collection of documents using automated means that identify those documents from said collection that match said input query,
(e) measuring a matching accuracy for said plurality of matching rules, and
(f) providing incentive means that help persuade said plurality of independent individuals to provide accurate matching rules,
whereby the subset of documents identified is an accurate response for said input query.

2. An automated computational system comprising
(a) a means to store a collection of documents,
(b) a means to collect a plurality of matching rules from a plurality of independent individuals,
(c) a means to associate each matching rule with a document contained in said collection of documents,
(d) a means to accept an input query,
(e) an automated means to use said plurality of matching rules to compute and list those documents from said collection that match said input query,
(f) a means to measure accuracy of said plurality of matching rules collected from each of said plurality of independent individuals,
(g) a means to use the measured accuracy to reward those individuals that have provided accurate matching rules,
whereby said plurality of independent individuals are encouraged to cooperate in ensuring accuracy of said plurality of matching rules.

3. A method for searching for documents in a collection comprising
(a) inviting substantially free advertisements for substantially all items contained in said collection,
(b) accepting a substantially free advertisement from a person knowledgeable about a document,
(c) accepting one or more of precise keyword matching rules from said person,
(d) accepting a search query from a user,
(e) executing said precise keyword matching rules on said search query to determine if said advertisement should be shown in response to said query,
(f) computing a trustworthiness rating for said advertisement using a database of previously collected feedback from earlier users,
(g) ranking said advertisement among others that match said query ordered by said trustworthiness rating,
(h) displaying the ranked list of matching advertisements to said user,
(i) obtaining feedback from user. about relevance of each item in said ranked list of matching advertisements,
(j) entering information related to said feedback on relevance of said advertisement obtained from said user into said database of previously collected feedback,
whereby the ranked list of free advertisements converges to a high quality unbiased search-response to said query.

4. The method of claim 1 further comprising,
collecting improved versions of previously collected matching rules from a plurality of independent individuals,
whereby the accuracy of the computed response continuously improves during the course of multiple iterations of the method.

5. The method of claim 4 further comprising
providing said plurality of independent individuals with the value of the measured accuracy of each of their matching rules,
whereby said plurality of independent individuals get feedback on how to improve their matching rules.

6. The automated computational system of claim 2 further comprising
a means to allow said plurality of independent individuals to edit and improve previously collected matching rules,
whereby the accuracy of the computed response continuously improves during the course of multiple uses of the system.

7. The automated computational system of claim 6 further comprising
a means to provide said plurality of independent individuals with the measured accuracy of their matching rules,
whereby said plurality of independent individuals get feedback on how to improve their matching rules.

8. The method of claim 1 wherein said matching rules are word patterns.

9. The method of claim 1 wherein said collection of documents is a set of web pages from the Internet.

10. The method of claim 1 wherein the step of measuring a matching accuracy further comprises
collecting feedback from users about the relevance of the presented results,
keeping a historical record of previously gathered feedback, and
using the current and historical feedback to estimate matching accuracy.

11. The method of claim 1 where granting incentives or disincentives further comprises
ordering the list of results so that a document that matches an accurate matching rule is shown at the top of the results
and a document that matches an inaccurate matching rule is shown lower down.

12. The method of claim 1 where processing said plurality of matching rules further comprises
storing the matching rules in a database indexed by the individual clauses in each matching rule,
enumerating all the possible clauses that might possibly match the input query,
searching the database to find if any of the enumerated clauses are present,
identifying the matching rules that contain any of the enumerated matching clauses,
verifying that the identified matching rules match the input query, and
collecting documents associated with the rules that matched the input query to form the result subset.

13. The system of claim 2 where a means to store a collection of documents is a database.

14. The system of claim 2 where a means to display a subset of documents consists of a web page that lists resource locator strings of each matched document.

15. The system of claim 2 where an automated means to match documents further comprises
a data storage means that is indexed by individual clauses in each matching rule,
a means to compute all the possible clauses that might possibly match the input query,
a means to search said data storage means to find if any of the enumerated clauses are present,
a means to identify the matching rules that contain any of the enumerated clauses,
a means to verify that the identified matching rules match the input query, and
a means to collect documents associated with the rules that matched the input query into a result subset.

16. The method of claim 1 where said independent individuals are web page publishers and the matching rules they provide are associated with their own documents.
